(19) United States
(12) Patent Application Publication
(10) Pub. No.: US 2022/0120363 A1
(43) Pub. Date: Apr. 21, 2022

(54) Push and Crimp Coupler

(71) Applicant: Carrier Corporation, Palm Beach Gardens, FL (US)

(72) Inventors: Christopher J. Fergusson, Haw River, NC (US); Ronald C. Mauney, Snow Camp, NC (US)

(21) Appl. No.: 17/450,468

(22) Filed: Oct. 11, 2021

Related U.S. Application Data
(60) Provisional application No. 63/198,434, filed on Oct. 19, 2020.

(51) Int. Cl. F16L 13/14; F16L 37/091

(52) U.S. Cl. CPC F16L 13/142; F16L 37/091

(57) ABSTRACT

A coupler for connecting to a tube (e.g., a siphon tube), a fire extinguisher incorporating the same, and a method for connecting a coupler to a tube are provided. The coupler includes a body defining a radially outward facing surface, a radially inward facing surface, a proximal end, and a distal end. The coupler includes a foldable section disposed at the proximal end. The foldable section including an unfolded position defining an unfolded internal diameter and a folded position defining a folded internal diameter. The foldable section is configured to receive a proximal end of the tube in the unfolded position. The foldable section is configured to secure to the circumferential groove in the folded position.

### CROSS REFERENCE TO A RELATED APPLICATION

The application claims the benefit of U.S. Provisional Application No. 63/198,434 filed Oct. 19, 2020, the contents of which are hereby incorporated in their entirety.

### BACKGROUND

Fire extinguishers play an important role in both residential and commercial fire protection (e.g., by storing fire extinguishing agent for later use in the event of a fire). To safely store and reliably expel the fire extinguishing agent, each fire extinguisher includes a plethora of different components. One common component of a fire extinguisher is a cylinder, which is typically used for holding the fire extinguishing agent (e.g., either under constant pressure, or capable of later pressurization using a separate cartridge). Each cylinder may be viewed to have base portion (e.g., viewed as the bottom end of the fire extinguisher) and a neck portion (e.g., viewed as the top end of the fire extinguisher). Typically fire extinguishers include a valve at the neck region, which is most commonly secured to the cylinder using threading. The valve is used to enable the controlled release of the fire extinguishing agent (e.g., by removing a pull pin and squeezing the upper and lower handle together).

Most commonly fire extinguishers include a siphon tube connected to the valve (e.g., using an adapter, which may also commonly be referred to as a coupler). This connection between the siphon tube and the valve (e.g., through the coupler) is critical to the fire extinguisher being able to withdraw fire extinguishing agent from within the cylinder. For example, if the connection between the coupler and the siphon tube becomes loose (e.g., loses its pressure seal) then the propellant may leak through the connection, which may reduce the amount of available propellant to carry the fire extinguishing agent from the bottom of the cylinder to be expelled toward the fire. As such it is vital that the siphon tube and the valve do not become detached or loose (e.g., from the coupler which is used to connect the two). The connections between the coupler and the siphon tube, and the coupler and the valve are most often completed by using one or more of: threading (which is reliant on the fitting being adequately tightened), soldering (which is reliant on proper application of the solder), and/or gluing (which is reliant on proper application and adequate curing of the glue). However, use of the above-mentioned to secure the siphon tube to the valve can cause the manufacturing process of the fire extinguishers to be overly complex and relatively expensive (e.g., when compared fire extinguishers that use alternative connection types). One alternative to the threaded, soldered, and/or glued types connections is a press fit connection. However, press fit connections can have union strength issues due to dimensional variances, which can cause connections to fail (e.g., which may result in an inoperable fire extinguisher if the siphon tube becomes detached from the coupler).

Accordingly, there remains a need for a coupler (e.g., for use in a fire extinguisher, etc.), and method for connecting a coupler to a tube, that has reduced complexity while still creating a reliable connection.

### BRIEF DESCRIPTION

According to one embodiment, a coupler for connecting to a tube comprising a circumferential groove is provided. The coupler including a body including a radially outward facing surface, a radially inward facing surface, a proximal end, and a distal end. The coupler including a foldable section disposed at the proximal end, the foldable section including an unfolded position defining an unfolded internal diameter and a folded position defining a folded internal diameter, the foldable section configured to receive a proximal end of the tube in the unfolded position and to secure to the circumferential groove in the folded position.

In accordance with additional or alternative embodiments, the coupler further includes a press fit section disposed adjacent to the foldable section, the press fit section defining a fixed internal diameter, the press fit section configured to secure to an external surface of the tube.

In accordance with additional or alternative embodiments, the unfolded internal diameter of the foldable section is greater than an external diameter of the tube, and the folded internal diameter of the foldable section is less than the external diameter of the tube.

In accordance with additional or alternative embodiments, the fixed internal diameter of the press fit section is less than the external diameter of the tube.

In accordance with additional or alternative embodiments, the coupler further includes a threaded section extending circumferentially around at least a portion of the radially outward facing surface of the body toward the distal end, the threaded section configured to receive a threaded portion of a valve.

In accordance with additional or alternative embodiments, the foldable section defines a width, the width of the foldable section being approximately equal to a width of the circumferential groove of the tube.

In accordance with additional or alternative embodiments, the press fit section defines a width, the width of the press fit section being approximately equal to a distance between the proximal end of the tube and a first edge of the circumferential groove of the tube.

In accordance with additional or alternative embodiments, the body is made of a malleable metal.

According to another aspect of the disclosure, a fire extinguisher including a cylinder, a siphon tube, and a coupler is provided. The cylinder provided for storing a fire extinguishing agent, the cylinder including a neck portion. The siphon tube is configured to extend downwardly into the cylinder from the neck portion, the siphon tube configured to deliver the fire extinguishing agent from within the cylinder, the siphon tube including a circumferential groove. The coupler is configured for connecting to a proximal end of the siphon tube. The coupler including a body including a radially outward facing surface, a radially inward facing surface, a proximal end and a distal end, and a foldable section disposed at the proximal end. The foldable section including an unfolded position defining an unfolded internal diameter and a folded position defining a folded internal diameter. The foldable section configured to receive a proximal end of the siphon tube in the unfolded position and to secure to the circumferential groove in the folded position.

In accordance with additional or alternative embodiments, the coupler further includes a press fit section disposed adjacent to the foldable section, the press fit section defining a fixed internal diameter, the press fit section configured to secure to an external surface of the siphon tube.

In accordance with additional or alternative embodiments, the unfolded internal diameter of the foldable section is greater than an external diameter of the siphon tube, and the folded internal diameter of the foldable section is less than the external diameter of the siphon tube.

In accordance with additional or alternative embodiments, the fixed internal diameter of the press fit section is less than the external diameter of the siphon tube.

In accordance with additional or alternative embodiments, the coupler further includes a threaded section extending circumferentially around at least a portion of the radially outward facing surface of the body toward the distal end, the threaded section configured to receive a threaded portion of a valve.

In accordance with additional or alternative embodiments, the foldable section of the coupler defines a width, the width of the foldable section being approximately equal to a width of the circumferential groove of the siphon tube.

In accordance with additional or alternative embodiments, the press fit section of the coupler defines a width, the width of the press fit section being approximately equal to a distance between the proximal end of the siphon tube and a first edge of the circumferential groove of the siphon tube.

In accordance with additional or alternative embodiments, the coupler and the siphon tube are made of a malleable metal.

According to another aspect of the disclosure, a method for connecting a coupler and a tube to allow the passage of at least one fluid is provided. The coupler including a foldable section disposed at a proximal end, and a press fit section disposed adjacent to the foldable section. The method includes a step for maintaining the foldable section of the coupler in the unfolded position, the foldable section defining an unfolded internal diameter in the unfolded position. The method includes a step for inserting a proximal end of the tube through the foldable section and into the press fit section, the press fit section configured to secure to an external surface of the tube. The method includes a step for positioning at least a portion of the foldable section in the folded position, the foldable section defnining a folded internal diameter in the folded position, the foldable section configured to secure to a circumferential groove of the tube in the folded position.

In accordance with additional or alternative embodiments, the positioning of at least a portion of the foldable section is completed by crimping.

In accordance with additional or alternative embodiments, the unfolded internal diameter of the foldable section is greater than an external diameter of the siphon tube, and the folded internal diameter of the foldable section and a fixed internal diameter of the press fit section are less than the external diameter of the siphon tube.

In accordance with additional or alternative embodiments, the at least one fluid is a fire extinguishing agent.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way. With reference to the accompanying drawings, like elements are numbered alike:

FIG. 1 is a cross-sectional side view of a coupler and a tube separated from one another in accordance with one aspect of the disclosure.

FIG. 2 is a cross-sectional side view of the tube press fit into the coupler with the foldable section of the coupler in an unfolded position in accordance with one aspect of the disclosure.

FIG. 3 is a cross-sectional side view of the tube press fit into the coupler with the foldable section of the coupler in a folded position in accordance with one aspect of the disclosure.

FIG. 4 is a perspective view of a fire extinguisher incorporating the coupler shown in FIGS. 1-3 to secure the siphon tube in accordance with one aspect of the disclosure.

FIG. 5 is a flow diagram illustrating a method for connecting a coupler and a tube to allow the passage of at least one fluid in accordance with one aspect of the disclosure.

### DETAILED DESCRIPTION

A coupler with reduced complexity, when compared to conventional couplers (e.g., which are commonly used to connect siphon tubes to valves in fire extinguishers), a fire extinguisher incorporating the coupler, and a method for connecting a coupler and a tube (e.g., a siphon tube) to allow the passage of at least one fluid (e.g., a fire extinguishing agent) are provided. The coupler may be viewed as a press fit coupler with a secondary securing feature (e.g., the foldable portion). The coupler described herein, through incorporating a foldable portion, may be particularly useful for more reliably connecting the siphon tube to the valve, which may help prevent, or at least mitigate, the fire extinguisher from becoming inoperable. It should be appreciated that the connection between the siphon tube and the coupler may be completed without relying on additional pressure seals, threading, soldering, or glue in certain instances. Instead of relying on threading, soldering, or glue, to increase the holding strength between the coupler and the tube, the coupler relies on a relatively simple foldable portion (e.g., which may be engaged with the tube through crimping the foldable portion). It should be appreciated that although the coupler is described herein to be particularly useful in connecting a siphon tube to a valve (e.g., for a fire extinguisher), the coupler may be useful to provide a connection to any tubing (e.g., water hose, refrigerant line, etc.).

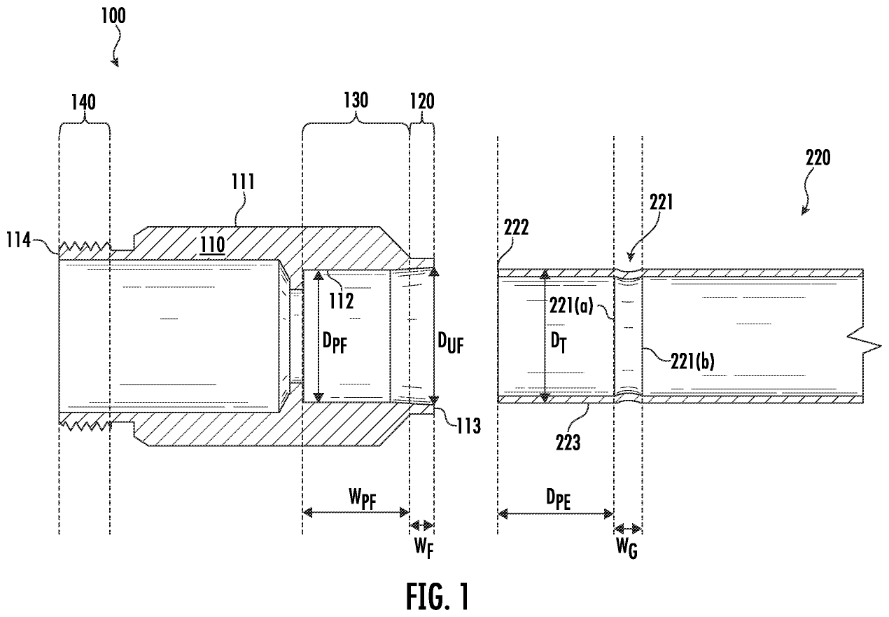

With reference now to the Figures, a cross-sectional side view of an exemplary coupler 100, in accordance with various aspects of the disclosure is shown in FIG. 1. As shown in FIG. 1, the coupler 100 may be used for connecting to a tube 220 (e.g., which may be a siphon tube, etc.) that may include a circumferential groove 221. It should be appreciated that connecting the coupler 100 to a tube 220 without a circumferential groove 221 (i.e., to a “plain tube”) may negatively affect the connection between the coupler 100 and the tube 220 (e.g., by altering the external diameter D_{T} of the tube 220 near the interface area). It was found that by adding a circumferential groove 221 to the tube 220 (e.g., through use of a rolling technique, etc.) that such deformation of the tube 220 may be avoided, therein mitigating negative effects on the pressure sealing properties of the press fit connection (i.e., created by the press fit section 130, described below). As such, in certain instances, the tube 220 described herein must include a circumferential groove 221.

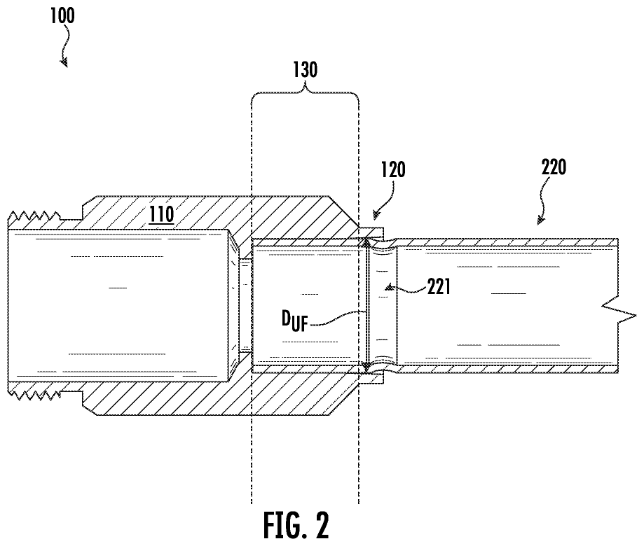

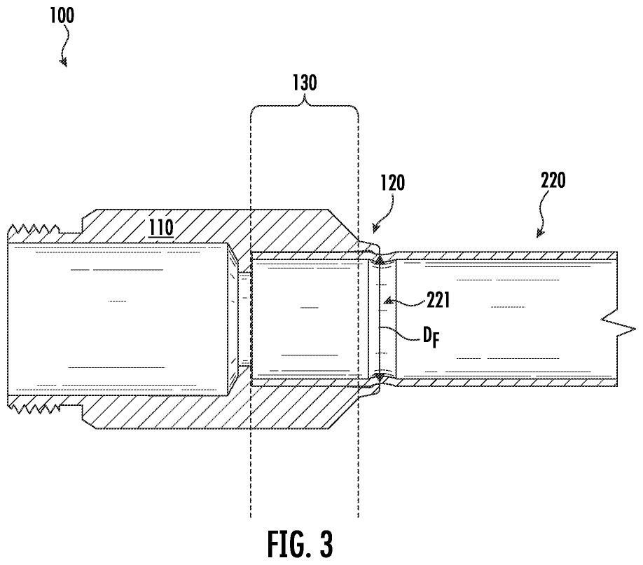

As shown in FIG. 1, the coupler 100 may be viewed to include a body 110 defining a radially outward facing surface 111, a radially inward facing surface 112, a proximal end 113, and a distal end 114. As shown, the coupler 100 may include a foldable section 120 disposed at the proximal end 113 of the body 110. The foldable section 113 may be configured to be manipulated (e.g., through crimping, etc.) so as to change from an unfolded position (shown in FIGS. 1 and 2) to a folded position (shown in FIG. 3). When in an unfolded position, the foldable section 120 may define an unfolded internal diameter D_{UF}. Likewise, when in a folded position, the foldable section 120 may define a folded internal diameter D_{F}. It should be appreciated that the folded internal diameter D_{F} may be smaller than the unfolded internal diameter D_{UF}.

As shown in FIGS. 1-3, the foldable section 120 may be configured to receive a proximal end 222 of the tube 220 in the unfolded position (shown in FIGS. 1 and 2) and to secure to the circumferential groove 221 of the tube 220 in the folded position (shown in FIG. 3). This foldable section 120 may help to increase the reliability of a press fit connection. It is envisioned that the coupler 100 described herein may be viewed as a press fit type coupler 100 with increased reliability when compared to existing couplers that do not include the foldable section 120 as described herein. It is envisioned that the foldable section 120, by securing to the circumferential groove 221, may help prevent, or at least mitigate connection failures. For example, instead of solely relying on the strength of the press fit connection, the coupler 100 described herein includes a foldable section 120 as an additional securing mechanism.

When viewed as a press fit type coupler 100 the coupler 100 may be viewed to include a press fit section 130. This press fit section 130 may be disposed adjacent to the foldable section 120. As shown in FIGS. 1-3, the press fit section 130 may define a fixed internal diameter D_{PF}. This press fit section 130 may be configured to secure to an external surface 223 of the tube 220. It should be appreciated that the coupler 100 described herein may reliably secure to the tube 220 without the need for additional pressure seals, threading, soldering, or gluing. Instead of relying on these mechanisms to reliably secure to the tube 220, the coupler 100 may be configured to have differently sized sections. For example, the unfolded internal diameter D_{UF} of the foldable section 120 may be greater than an external diameter D_{T} of the tube 220 (e.g., which may allow the proximal end 222 of the tube 220 to enter into the proximal end 113 of the coupler 100). In addition, the fixed internal diameter D_{PF} of the press fit section 130 may be less than the external diameter D_{T} of the tube 220 (e.g., which may allow the press fit section 130 to secure to the external surface 223 of the tube 220 when the tube 220 is inserted). It should be appreciated that the tube 220 may be made of a malleable metal such as aluminum, etc. that allows the tube 220 to fold inward on itself when inserted into the press fit section 130 of the coupler 100. To ensure that the tube 220 remain connected with the coupler 100 in the event of a failure of the connection between the press fit section 130 and the external surface 223 of the tube 200, the folded internal diameter D_{F} of the foldable section 120 may be less than the external diameter D_{T} of the tube 220 (e.g., so as to secure to the tube 220 when in the folded position). As mentioned above, the foldable section 120 may be configured to secure to the circumferential groove 221 of the tube 220.

Although described above that the coupler 100 may secure to the tube 220 without the use of threading on the proximal end 113, it should be appreciated that the coupler 100 may include threading, etc. on the distal end 113. As shown in FIGS. 1-3, in certain instances the coupler 100 may be viewed to include a threaded section 140, which may extend circumferentially around at least a portion of the radially outward facing surface 111 of the body 110 toward the distal end 114 of the coupler 100. This threaded section 140, as described below, may enable the coupler 100 to connect to another components (e.g., a valve of a fire extinguisher 200, etc.), which may enable a fluid (e.g., such as fire extinguishing agent) to pass through the tube 220, the coupler 100, and the valve (when included). It should be appreciated, although not shown, that the coupler 100 may include an additional foldable section on the distal end 114 instead of incorporating the threaded section 140 (e.g., to connect to the valve, etc.).

To ensure that the foldable section 120 of the coupler 100 aligns with the circumferential groove 221 of the tube 200 each section 120, 130 of the coupler 100 may be configured according to the dimensioning of the tube 220. For example, the foldable section 120 may have a width W_{F} that is approximately equal (e.g., within 0.05 inches) of the width W_{G} of the circumferential groove 221 of the tube 220. In addition, the press fit section 130 may have width W_{PF} that is approximately equal (e.g., within 0.05 inches) to the distance D_{PE} between the proximal end 222 of the tube 220 and the first edge 221(a) of the circumferential groove 221 of the tube 220. It should be appreciated that the width W_{G} of the circumferential groove 221 may be defined between the first edge 221(a) and the second edge 221(b) of the circumferential groove 221. It is envisioned that, when inserted completely, the proximal end 222 of the tube 220 may extend into the coupler 100 to the combined widths (W_{F}+W_{PF}) of the foldable section 120 and the press fit section 130, which may enable the foldable section 120 to engage the circumferential groove 221 when placed in the folded position (as shown in FIG. 3). It should be appreciated that like the tube 220, the coupler 100 may be made of a malleable metal such as aluminum, etc., which may enable the foldable section 120 to be placed in the folded position using any suitable crimping technique, etc.

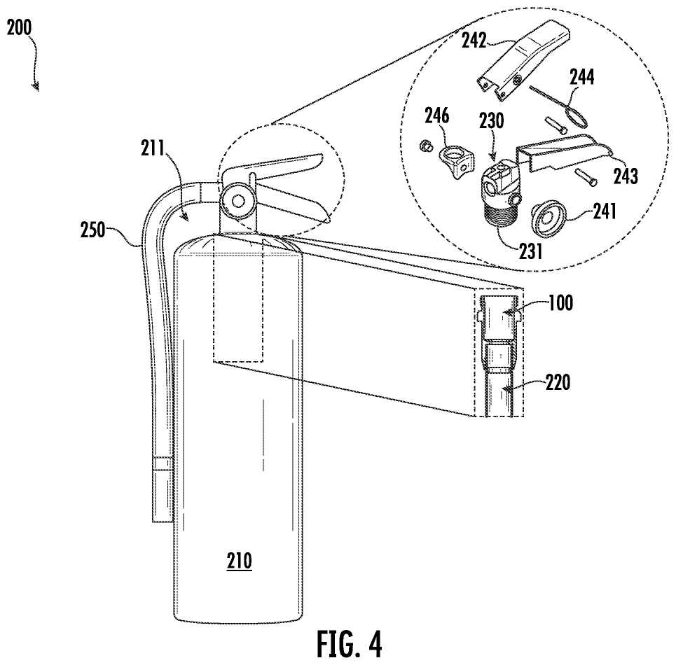

As mentioned above, the coupler 100 may be particularly useful as a component of a fire extinguisher 200 (as shown in FIG. 4). For example, the coupler 100 may be useful in connecting a siphon tube 220 to a valve 230 to enable the fire extinguishing agent to be siphoned out of the fire extinguisher 200. As shown in FIG. 4, the fire extinguishing agent may be housed within a cylinder 110, which may be viewed to include a neck portion 211 (e.g., positioned near the top of the fire extinguisher 200). The siphon tube 220 may extend downwardly into the cylinder 210 from the neck portion 211. The siphon tube 220 may be configured to deliver fire extinguishing agent from within the cylinder 210. As shown in FIGS. 1-3, the siphon tube 220 may include a circumferential groove 221. The coupler 100, as described above, may connect to the siphon tube 220 by incorporating a foldable section 120 and a press fit section 130. The foldable section 120 being configured to engage the circumferential groove 221, and the press fit section 130 being configured to engage the external surface 223 of the siphon tube 220.

It is envisioned that the coupler 100 may help prevent, or at least mitigate, the siphon tube 220 from becoming disconnected from the valve 230, which, if occurring, may cause the fire extinguisher 200 to be inoperable (e.g., unable to effectively expel the fire extinguishing agent). It should be appreciated the fire extinguisher 200 shown in FIG. 4 and described herein may operate in the same manner as a conventional fire extinguisher (e.g., which may incorporate a differently configured coupler (not shown)). For example, as with a conventional fire extinguisher, the fire extinguisher shown in FIG. 4, may require the user to release/remove a pin 244 and squeeze the handles 242, 243 to discharge the fire extinguishing agent. Like conventional fire extinguishers, the fire extinguisher 200 described herein may include additional components such as gauges 241 (e.g., to show the pressure within the cylinder 210), hangers 246 (e.g., to allow the fire extinguisher 200 to be mounted in a given location), hose 250 (e.g., to allow the fire extinguishing agent to be directed by the user of the fire extinguisher 200 toward the fire), etc. It should be appreciated that the coupler 100, and the fire extinguisher 200 described herein may be useful in a number of different settings (e.g., both residential and commercial fire protection).

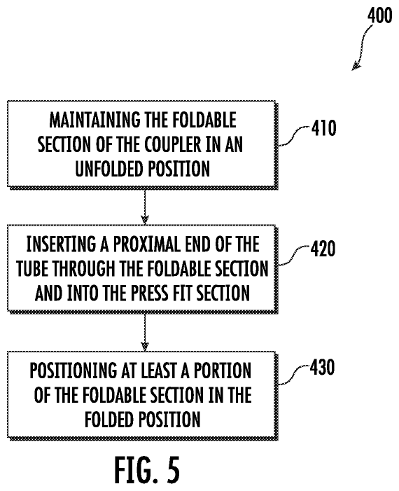

Regardless of the setting in which the coupler 100 and/or the fire extinguisher are utilized, the method for connecting the coupler 100 and the tube 220 may be the same. An exemplary method 400 for connecting a coupler 100 and a tube 220 to allow the passage of at least one fluid (e.g., a fire extinguishing agent, etc.) is shown in FIG. 5. The method 400 may be performed, for example, using the exemplary coupler 100 shown in FIGS. 1-3, and may be part of the manufacturing process of the fire extinguisher 200 shown in FIG. 4. The method 400 includes step 410 for maintaining the foldable section 120 of the coupler 100 in the unfolded position (as shown in FIG. 1), the foldable section 120 defining an unfolded internal diameter D_{UF} in the unfolded position. The method 400 includes step 420 for inserting a proximal end 222 of the tube 220 through the foldable section 120 and into the press fit section 130 (as shown in FIG. 2). The press fit section 130 configured to secure to an external surface 223 of the tube 220. The method 400 includes step 430 for positioning (e.g., through crimping, etc.) at least a portion of the foldable section 120 in the folded position (as shown in FIG. 3). The foldable section 120 defining a folded internal diameter D_{F} in the folded position. As described above, the foldable section 120 may be configured to secure to the circumferential groove 221 of the tube 220 in the folded position. It is envisioned that this method 400 may provide a more reliable press fit connection than what is possible by existing couplers.

The use of the terms “a” and “and” and “the” and similar referents, in the context of describing the invention, are to be construed to cover both the singular and the plural, unless otherwise indicated herein or cleared contradicted by context. The use of any and all example, or exemplary language (e.g., “such as”, “e.g.”, “for example”, etc.) provided herein is intended merely to better illuminate the invention and does not pose a limitation on the scope of the invention unless otherwise claimed. No language in the specification should be construed as indicating any non-claimed elements as essential to the practice of the invention.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A coupler for connecting to a tube comprising a circumferential groove, the coupler comprising:
a body comprising a radially outward facing surface, a radially inward facing surface, a proximal end, and a distal end; and
a foldable section disposed at the proximal end, the foldable section comprising an unfolded position defining an unfolded internal diameter and a folded position defining a folded internal diameter, the foldable section configured to receive a proximal end of the tube in the unfolded position and to secure to the circumferential groove in the folded position.

2. The coupler of claim 1, further comprising a press fit section disposed adjacent to the foldable section, the press fit section comprising a fixed internal diameter, the press fit section configured to secure to an external surface of the tube.

3. The coupler of claim 1, wherein the unfolded internal diameter of the foldable section is greater than an external diameter of the tube, and the folded internal diameter of the foldable section is less than the external diameter of the tube.

4. The coupler of claim 2, wherein the fixed internal diameter of the press fit section is less than the external diameter of the tube.

5. The coupler of claim 1, further comprising a threaded section extending circumferentially around at least a portion of the radially outward facing surface of the body toward the distal end, the threaded section configured to receive a threaded portion of a valve.

6. The coupler of claim 1, wherein the foldable section comprises a width, the width of the foldable section being approximately equal to a width of the circumferential groove of the tube.

7. The coupler of claim 2, wherein the press fit section comprises a width, the width of the press fit section being approximately equal to a distance between the proximal end of the tube and a first edge of the circumferential groove of the tube.

8. The coupler of claim 1, wherein the body is comprised of a malleable metal.

9. A fire extinguisher comprising:
a cylinder for storing a fire extinguishing agent, the cylinder comprising a neck portion;
a siphon tube extending downwardly into the cylinder from the neck portion, the siphon tube configured to deliver the fire extinguishing agent from within the cylinder, the siphon tube comprising a circumferential groove; and
a coupler for connecting to a proximal end of the siphon tube, the coupler comprising a body comprising a radially outward facing surface, a radially inward facing surface, a proximal end and a distal end, and a foldable section disposed at the proximal end, the foldable section comprising an unfolded position defining an unfolded internal diameter and a folded position defining a folded internal diameter, the foldable section configured to receive a proximal end of the siphon tube in the unfolded position and to secure to the circumferential groove in the folded position.

10. The fire extinguisher of claim 9, wherein the coupler further comprises a press fit section disposed adjacent to the foldable section, the press fit section comprising a fixed internal diameter, the press fit section configured to secure to an external surface of the siphon tube.

11. The fire extinguisher of claim 9, wherein the unfolded internal diameter of the foldable section is greater than an external diameter of the siphon tube, and the folded internal diameter of the foldable section is less than the external diameter of the siphon tube.

12. The fire extinguisher of claim 10, wherein the fixed internal diameter of the press fit section is less than the external diameter of the siphon tube.

13. The fire extinguisher of claim 9, wherein the coupler further comprises a threaded section extending circumferentially around at least a portion of the radially outward facing surface of the body toward the distal end, the threaded section configured to receive a threaded portion of a valve.

14. The fire extinguisher of claim 9, wherein the foldable section of the coupler comprises a width, the width of the foldable section being approximately equal to a width of the circumferential groove of the siphon tube.

15. The coupler of claim 10, wherein the press fit section of the coupler comprises a width, the width of the press fit section being approximately equal to a distance between the proximal end of the siphon tube and a first edge of the circumferential groove of the siphon tube.

16. The fire extinguisher of claim 9, wherein the coupler and the siphon tube are comprised of a malleable metal.

17. A method for connecting a coupler and a tube to allow the passage of at least one fluid, the coupler comprising a foldable section disposed at a proximal end, and a press fit section disposed adjacent to the foldable section, the method comprising:
maintaining the foldable section of the coupler in the unfolded position, the foldable section comprising an unfolded internal diameter in the unfolded position;
inserting a proximal end of the tube through the foldable section and into the press fit section, the press fit section configured to secure to an external surface of the tube; and
positioning at least a portion of the foldable section in the folded position, the foldable section comprising a folded internal diameter in the folded position, the foldable section configured to secure to a circumferential groove of the tube in the folded position.

18. The method of claim 17, wherein the positioning of at least a portion of the foldable section is completed by crimping.

19. The method of claim 17, the unfolded internal diameter of the foldable section is greater than an external diameter of the siphon tube, and the folded internal diameter of the foldable section and a fixed internal diameter of the press fit section are less than the external diameter of the siphon tube.

20. The method of claim 17, wherein the at least one fluid is a fire extinguishing agent.
